(19) United States
(12) Patent Application Publication
(10) Pub. No.: US 2024/0373819 A1
(43) Pub. Date: Nov. 14, 2024

(54) HEATED ANIMAL FOOD BOWL DEVICE

(71) Applicant: Maria Espinosa, East Stroudsburg, PA (US)

(72) Inventor: Maria Espinosa, East Stroudsburg, PA (US)

(21) Appl. No.: 18/660,486

(22) Filed: May 10, 2024

Related U.S. Application Data
(60) Provisional application No. 63/501,408, filed on May 11, 2023.

(51) Int. Cl. A01K 5/01

(52) U.S. Cl. CPC A01K 5/0128

(57) ABSTRACT

A heated animal food bowl device is provided. The device is comprised of a heating functionality to maintain animal food at desirable temperatures while outdoors in cold temperatures. The base of the device may feature removable and non-removable bowls that fit into one or more openings in the base. At least one heating element heats the bowl, thus warming the contents to temperatures ranging from thirty-three to one hundred and forty degrees fahrenheit. The heating element is powered by a battery that may be recharged via a charging port or a solar panel.

### CROSS-REFERENCE TO RELATED APPLICATION

The present application claims priority to, and the benefit of, U.S. Provisional Application No. 63/501,408, which was filed on May 11, 2023, and is incorporated herein by reference in its entirety.

### FIELD OF THE INVENTION

The present invention relates generally to the field of animal feeding bowls. More specifically, the present invention relates to a heated animal food bowl device comprised of a food bowl with a heating element that ensures food within the bowl remains a desired temperature and does not freeze when in a cold temperature environment. Accordingly, the present disclosure makes specific reference thereto. Nonetheless, it is to be appreciated that aspects of the present invention are also equally applicable to other like applications, devices, and methods of manufacture.

### BACKGROUND

Stray animals often face significant challenges in securing adequate food and water, particularly during the harsh winter months. These animals might not only struggle to locate these essential resources but may also reject food if it is cold, increasing their risk of severe starvation. Furthermore, consuming cold or frozen food can be harsh on an animal's digestive system, potentially leading to various illnesses. Another concern during winter is that water left outdoors for stray animals can freeze, rendering it undrinkable and further complicating the survival chances of said animals.

Therefore, there exists a long-felt need in the art for a device for feeding animals. There also exists a long-felt need in the art for a heated animal food bowl device. Furthermore, there exists a long-felt need in the art for a heated animal food bowl device that adequately heats food or liquid within the bowl in cold temperatures. More specifically, there exists a long-felt need in the art for a heated animal food bowl device that prevents the freezing of animal food left outdoors in cold temperatures.

The subject matter disclosed and claimed herein, in one embodiment thereof, comprises a heated animal food bowl device. The device is comprised of a heating functionality to maintain animal food at desirable temperatures while outdoors in cold temperatures. The base of the device may feature removable and non-removable bowls that fit into one or more openings in the base. At least one heating element heats the bowl, thus warming the contents to temperatures ranging from thirty-three to one hundred and forty degrees fahrenheit. The heating element is powered by a battery that may be recharged via a charging port or a solar panel.

In this manner, the heated animal food bowl device of the present invention accomplishes all the forgoing objectives and provides a device for feeding animals. More specifically, the device provides an animal food bowl that adequately heats food or liquid within the bowl in cold temperatures. Furthermore, the device prevents the freezing of animal food left outdoors in cold temperatures.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a heated animal food bowl device comprised of a bowl for feeding an animal, wherein the bowl is heated by at least one heating element. More specifically, the device is comprised of a base that preferably has at least one opening that accepts at least one removable bowl. In a different embodiment, the bowl is non-removable.

The base is also comprised of at least one heating element. The heating element may be positioned below a bottom wall and/or behind at least one side wall of the opening. This allows the bowl, and any liquid or food within the bowl, to be heated. The temperature of the heating element (as well as the powering on/off of the element) may be controlled via at least one button, switch, etc., or other similar control mechanism.

The heating element is powered by at least one battery. The battery may be removable or non-removable from the base. The battery may also be disposable or rechargeable. In a non-removable and rechargeable embodiment, the battery may be charged by at least one charging port. In a further embodiment, the battery may be recharged via at least one solar panel on the base.

The present invention is also comprised of a method of using the device. First, a device is provided comprised of a base comprised of at least one heating element and at least one bowl. Then, the bowl can be filled with a liquid and/or a food. Then, the heating element can be powered on and a temperature of the heating element can be selected by at least one button.

Accordingly, the heated animal food bowl device of the present invention is particularly advantageous as it provides a device for feeding animals. More specifically, the device provides an animal food bowl that adequately heats food or liquid within the bowl in cold temperatures. Furthermore, the device prevents the freezing of animal food left outdoors in cold temperatures. In this manner, the heated animal food bowl device overcomes the limitations of existing animal food bowls known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a heated animal food bowl device of the present invention in accordance with the disclosed architecture;

FIG. 2 illustrates a perspective view of one potential embodiment of a heated animal food bowl device of the present invention with a removable bowl in accordance with the disclosed architecture;

FIG. 3 illustrates a bottom view of one potential embodiment of a heated animal food bowl device of the present invention in accordance with the disclosed architecture; and

FIG. 4 illustrates a flowchart of a method of using one potential embodiment of a heated animal food bowl device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for feeding animals. There also exists a long-felt need in the art for a heated animal food bowl device. Furthermore, there exists a long-felt need in the art for a heated animal food bowl device that adequately heats food or liquid within the bowl in cold temperatures. More specifically, there exists a long-felt need in the art for a heated animal food bowl device that prevents the freezing of animal food left outdoors in cold temperatures.

The present invention, in one exemplary embodiment, is comprised of a heated animal food bowl device comprised of a bowl for feeding an animal, wherein the bowl is heated by at least one heating element. More specifically, the device is comprised of a base that preferably has at least one opening that accepts at least one removable bowl. In a different embodiment, the bowl is non-removable.

The base is also comprised of at least one heating element that may be positioned below a bottom wall and/or behind at least one side wall of the opening to allow the bowl, and any liquid or food within the bowl, to be heated. The temperature of the heating element (as well as the powering on/off of the element) may be controlled via at least one button, switch, etc. or other similar control mechanism.

The heating element is powered by at least one battery that may be removable or non-removable from the base. The battery may also be disposable or rechargeable. In a non-removable and rechargeable embodiment, the battery may be charged by at least one charging port. In a further embodiment, the battery may be recharged via at least one solar panel on the base.

The present invention is also comprised of a method of using the device. First, a device is provided comprised of a base comprised of at least one heating element and at least one bowl. Then, the bowl can be filled with a liquid and/or a food. Then, the heating element can be powered on and a temperature of the heating element can be selected by at least one button.

Accordingly, the heated animal food bowl device of the present invention is particularly advantageous as it provides a device for feeding animals. More specifically, the device provides an animal food bowl that adequately heats food or liquid within the bowl in cold temperatures. Furthermore, the device prevents the freezing of animal food left outdoors in cold temperatures. In this manner, the heated animal food bowl device overcomes the limitations of existing animal food bowls known in the art.

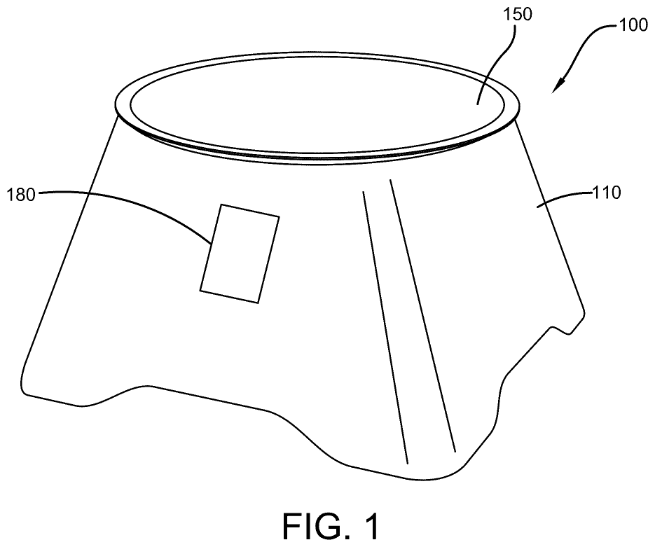

Referring initially to the drawings, FIG. 1 illustrates a perspective view of one potential embodiment of a heated animal food bowl device 100 of the present invention in accordance with the disclosed architecture. The device 100 is comprised of a bowl 150 for feeding an animal, wherein the bowl 150 is heated by at least one heating element 140.

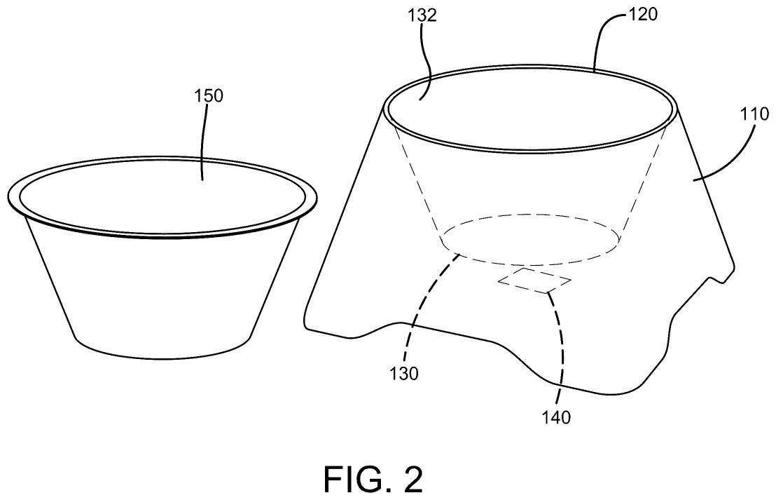

The device 100 is comprised of a base 110. The base 110 may be made out of any material and may be any shape, size, and configuration. The base 110 is preferably made from a stainless steel material. The base 110 preferably has at least one opening 120 that accepts at least one removable bowl 150, as seen in FIG. 2. In a different embodiment, the bowl 150 is non-removable.

The bowl 150 may be any shape, size, and configuration of feeding bowl. The bowl 150 is preferably made from a stainless steel material. The bowl 150 may be made from any material. In one embodiment, the base 110 accommodates a plurality of bowls 150 in a plurality of openings 120.

The base 110 is comprised of at least one heating element 140. The heating element 140 may be positioned below a bottom wall 130 and/or behind at least one side wall 132 of the opening 120. This allows the bowl 150, and any liquid or food within the bowl 150, to be heated. The heating element 140 is preferably an electric heating coil, but may be any heating element of any type. The heating element 140 may provide heat from any temperature between thirty-three and one-hundred and forty degrees fahrenheit. The temperature of the heating element 140 (as well as the powering on/off of the element 140) may be controlled via at least one button 142, switch, etc. or other similar control mechanism.

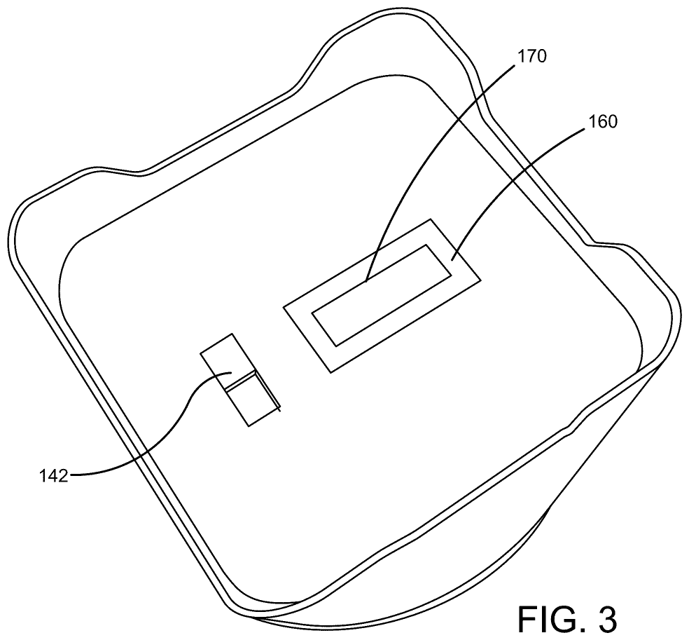

The heating element 140 is powered by at least one battery 160, as seen in FIG. 3. The battery 160 may be removable or non-removable from the base 110. The battery 160 may also be disposable or rechargeable. In a non-removable and rechargeable embodiment, the battery 160 may be charged by at least one charging port 170 of any type, such as but not limited to a USB charging port. In a further embodiment, the battery 160 may be recharged via at least one solar panel 180 on the base 110. The panel 180 may be any solar panel type and configuration.

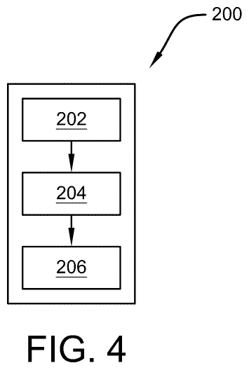

The present invention is also comprised of a method of using 200 the device 100, as seen in FIG. 4. First, a device 100 is provided comprised of a base 110 comprised of at least one heating element 140 and at least one bowl 150 [Step 202]. Then, the bowl 150 can be filled with a liquid and/or a food [Step 204]. Then, the heating element 140 can be powered on and a temperature of the heating element 140 can be selected by at least one button 142 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “heated animal food bowl device” and “device” are interchangeable and refer to the heated animal food bowl device 100 of the present invention.

Notwithstanding the forgoing, the heated animal food bowl device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the heated animal food bowl device 100 as shown in the FIGS. are for illustrative purposes only, and that many other sizes and shapes of the heated animal food bowl device 100 are well within the scope of the present disclosure. Although the dimensions of the heated animal food bowl device 100 are important design parameters for user convenience, the heated animal food bowl device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heated animal food bowl device comprising:
a base comprised of an opening, a heating element, and a battery; and
a bowl that is removable from the opening of the base.

2. The heated animal food bowl device of claim 1, wherein the base is comprised of a stainless steel material.

3. The heated animal food bowl device of claim 1, wherein the bowl is comprised of a stainless steel material.

4. The heated animal food bowl device of claim 1, wherein the heating element is comprised of an electric heating coil.

5. The heated animal food bowl device of claim 1, wherein the heating element produces a temperature between thirty-three and one-hundred and forty degrees fahrenheit.

6. The heated animal food bowl device of claim 1, wherein the battery is removable from the base.

7. The heated animal food bowl device of claim 1, wherein the battery is comprised of a rechargeable battery.

8. The heated animal food bowl device of claim 7, wherein the battery is comprised of a charging port.

9. The heated animal food bowl device of claim 1, wherein the heating element is positioned below a bottom wall of the opening.

10. The heated animal food bowl device of claim 1, wherein the heating element is positioned behind a side wall of the opening.

11. A heated animal food bowl device comprising:
a base comprised of:
a bowl;
a heating element;
a battery;
a solar panel; and
a button.

12. The heated animal food bowl device of claim 11, wherein the battery is comprised of a rechargeable battery that receives power from the solar panel.

13. The heated animal food bowl device of claim 11, wherein the base is comprised of a stainless steel material.

14. The heated animal food bowl device of claim 11, wherein the bowl is comprised of a stainless steel material.

15. The heated animal food bowl device of claim 11, wherein the heating element is comprised of an electric heating coil.

16. The heated animal food bowl device of claim 11, wherein the heating element produces a temperature between thirty-three and one-hundred and forty degrees fahrenheit.

17. A method of using a heated animal food bowl device, the method comprising the following steps:
providing a heated animal food bowl device comprised of a base comprised of a heating element and a bowl;
placing a food or a liquid in the bowl; and
powering on and selecting a temperature of the heating element.

18. The method of using a heated animal food bowl device of claim 17, wherein the heating element produces a temperature between thirty-three and one-hundred and forty degrees fahrenheit.

19. The method of using a heated animal food bowl device of claim 17, wherein the heating element is comprised of an electric heating coil.

20. The method of using a heated animal food bowl device of claim 17, wherein the heated animal food bowl device is comprised of a button that controls the heating element.
